(19) United States
(12) Patent Application Publication
(10) Pub. No.: US 2025/0310276 A1
(43) Pub. Date: Oct. 2, 2025

(54) Flood Suppression of Link-Local Multicast and Broadcast Traffic

(71) Applicant: Arista Networks, Inc., Santa Clara, CA (US)

(72) Inventors: Ravikumar Siruvallur CHANDRASEKARAN, San Jose, CA (US); Purushothaman NANDAKUMARAN, Milpitas, CA (US); Dennis SAM, Vancouver (CA); Xiaohui GONG, Burnaby (CA); Victor WEN, San Jose, CA (US); Sourav BASU, Bangalore (IN); Bharath Bhirthi SOMAYAJI, Bangalore (IN)

(21) Appl. No.: 18/616,777

(22) Filed: Mar. 26, 2024

(51) Int. Cl. H04L 49/201; H04L 45/745; H04L 47/12

(52) U.S. Cl. CPC H04L 49/201; H04L 45/74591; H04L 47/12

(57) ABSTRACT

Techniques for suppressing the flooding of link-local multicast and broadcast traffic are provided. In certain embodiments, these techniques include receiving, by a network device, a link-local multicast or broadcast message from an endpoint, where the message pertains to a networking protocol that uses link-local multicast and/or broadcast transmissions; dropping, by a data plane of the network device, the message in hardware, such that the message is not flooded on the local network segment of the endpoint; copying, by the data plane, the message to the device's central processing unit (CPU); and processing, by software running on the CPU, the message in accordance with the message's networking protocol (and in a manner that eliminates the need to flood the message).

### BACKGROUND

Many networking protocols employ link-local multicast or broadcast transmissions, which refer to transmissions that are confined to a single local segment in a network, such as a single subnet or virtual local area network (VLAN). For example, multicast Domain Name System (mDNS) is a networking protocol defined in Request for Comments (RFC) 6762 that uses link-local multicast to resolve hostnames and enable service discovery in small networks without the need for a dedicated name server. Further, Dynamic Host Configuration Protocol (DHCP) is a networking protocol defined in RFC 2131, RFC 3315, and RFC 8415 that uses broadcast (for DHCPv4) or link-local multicast (for DHCPv6) to enable dynamic assignment of Internet Protocol (IP) addresses to host devices.

One problem common to mDNS, DHCP, and other similar networking protocols is that they often generate large amounts of link-local multicast or broadcast traffic due to the way in which they flood their respective protocol messages throughout the local network segments they operate in. The presence of such large amounts of link-local multicast or broadcast traffic can result in degraded network performance, high overhead, and reduced network reliability. This is particularly problematic in network deployments that employ a wireless medium, as discussed in RFC 9119.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example network in accordance with certain embodiments of the present disclosure.

FIG. 2 depicts a modified version of the network of FIG. 2 in accordance with certain embodiments of the present disclosure.

FIG. 3 depicts an mDNS flood suppression workflow in accordance with certain embodiments of the present disclosure.

FIG. 4 depicts a TCAM setup workflow for mDNS flood suppression in accordance with certain embodiments of the present disclosure.

FIG. 5 depicts an mDNS announcement workflow with mDNS flood suppression enabled in accordance with certain embodiments of the present disclosure.

FIG. 6 depicts an mDNS query workflow with mDNS flood suppression enabled in accordance with certain embodiments of the present disclosure.

FIG. 7 depicts another example network in accordance with certain embodiments of the present disclosure.

FIG. 8 depicts an mDNS announcement workflow with mDNS flood suppression enabled in the network of FIG. 7 in accordance with certain embodiments of the present disclosure.

FIG. 9 depicts an mDNS query workflow with mDNS flood suppression enabled in the network of FIG. 7 in accordance with certain embodiments of the present disclosure.

FIG. 10 depicts another example network in accordance with certain embodiments of the present disclosure.

FIG. 11 depicts another example network in accordance with certain embodiments of the present disclosure.

FIG. 12 depicts a modified version of the network of FIG. 11 in accordance with certain embodiments of the present disclosure.

FIG. 13 depicts another example network in accordance with certain embodiments of the present disclosure.

FIG. 14 depicts a TCAM setup workflow for DHCP flood suppression in accordance with certain embodiments of the present disclosure.

FIG. 15 depicts a workflow for handling a DHCP discover/solicit or request message with DHCP flood suppression enabled in accordance with certain embodiments of the present disclosure.

FIG. 16 depicts an example network device in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for suppressing the flooding of link-local multicast and broadcast traffic on one or more local network segments of a network. At a high level, these techniques involve receiving, by a network device, a link-local multicast or broadcast message from an endpoint, where the message pertains to a networking protocol that uses link-local multicast and/or broadcast transmissions (e.g., mDNS, DHCP, etc.); dropping, by a data plane of the network device, the message in hardware, such that the message is not flooded on the local network segment of the endpoint; copying, by the data plane, the message to the device's central processing unit (CPU); and processing, by software running on the CPU, the message in accordance with the message's networking protocol (and in a manner that eliminates the need to flood the message). With this general approach, the amount of link-local multicast and broadcast traffic generated by the networking protocol can be significantly reduced, thereby leading to improved network performance, efficiency, and reliability.

Section (1) below details a set of embodiments that are directed to flood suppression of mDNS traffic and section (2) below details a set of embodiments that are directed to flood suppression of DHCP traffic. It should be appreciated that these embodiments are illustrative and that the general approach noted above may be applied to any networking protocol for the purpose of reducing the amount of link-local multicast and/or broadcast traffic generated by that protocol.

1. mDNS Flood Suppression

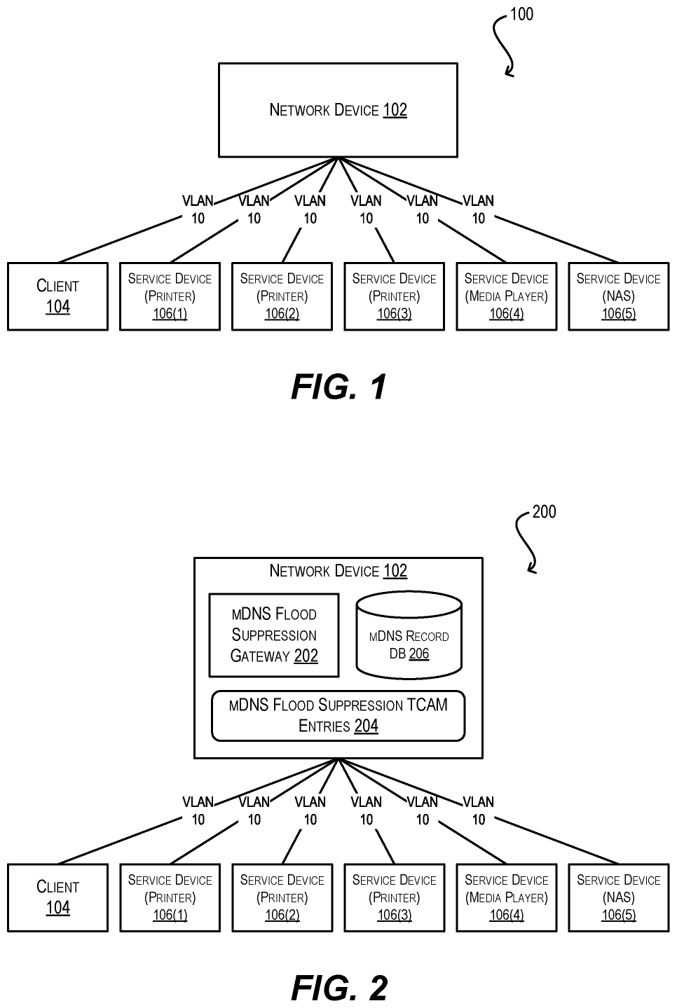

FIG. 1 is a simplified block diagram of an example network 100 in which the techniques of the present disclosure may be implemented. As shown, network 100 comprises a network device (e.g., switch) 102 that is locally connected with five endpoints: a client 104 and five service devices 106(1)-(5). “Locally connected” means that network device 102 can communicate with these endpoints without the need for routing the communications through an intermediary Layer 3 switch/router.

Client 104 is a computing device such as a laptop, mobile phone, desktop computer system, or the like. Service devices 106(1)-(5) are devices that provide certain functionalities or capabilities (services) to clients like client 104. These service devices include three printers 106(1)-(3) that provide printing services, a digital media player 106(4) that provides a multimedia streaming service, and a network-attached storage (NAS) device 106(5) that provides a file sharing service. Client 104 and service devices 106(1)-(5) are all part of a single local network segment managed by network device 102, namely VLAN 10.

In accordance with the present disclosure, network device 102, client 104, and service devices 106(1)-(5) are configured to support service discovery within VLAN 10 via mDNS. As mentioned previously, mDNS is a networking protocol defined in RFC 6762 that leverages a form of multicast known as link-local multicast. Generally speaking, multicast involves broadcasting, using a specially reserved multicast address range, packets from a sender to a group of interested receivers via a single transmission (rather than via multiple transmissions for the multiple receivers). Link-local multicast involves performing this broadcasting within a single local network segment. And mDNS uses link-local multicast to allow clients to discover the addresses of services that reside on the same local network segment, without relying on a dedicated/centralized name server.

By way of example, the following is a typical mDNS query workflow that may be initiated by client 104 for discovering printing services in VLAN 10:
Client 104 transmits an mDNS query message with a payload comprising a request for discovering printing services. This mDNS query takes the form of a multicast User Datagram Protocol (UDP) packet that specifies a special link-local multicast address (224.0.0.251 for IPV4 and FF02::FB for IPV6) and a special destination port (5353) as the destination address and the destination port respectively.
Network device 102 receives the mDNS query and broadcasts (floods) it to all devices in the same local network segment as client 104 (i.e., VLAN 10).
Service devices in VLAN 10 that are the target of the mDNS query, such as printers 106(1)-(3), handle and reply to the query by transmitting an mDNS response message with a payload including information regarding its printing service (e.g., printer name, printer IP address, etc.). If the mDNS query indicated (via the setting of a unicast response bit) that a unicast response should be sent, the mDNS response will take the form of a unicast UDP packet destined solely for client 104. In this scenario, the mDNS response will specify a special source port of 5353. Alternatively, if the mDNS query did not indicate that a unicast response should be sent, the mDNS response will take the form of a multicast UDP packet that is destined for the special link-local multicast address and special destination port noted above.
Network device 102 receives each mDNS response and either forwards it directly to client 104 (in the case of a unicast response) or floods it to all devices in VLAN 10 (in the case of a multicast response).
Client 104 receives the mDNS responses from network device 102 and processes each response by creating, in an mDNS cache local to the client, a service record for the printing service identified in the response.

Further, the following is a typical mDNS announcement workflow that may be initiated by printer 106(1) for announcing the availability of its printer service to clients on VLAN 10. Printer 106(1) may initiate this workflow when it joins network 100, such as upon being powered on or awoken from a sleep state. A similar workflow may be initiated by the other service devices 106(2)-(5) for announcing the availability of their respective services.
Printer 106(1) transmits an mDNS announcement message with a payload including information pertaining to its printing service (e.g., printer name, printer IP address, etc.). This mDNS announcement, which can be understood as an unsolicited mDNS response, takes the form of a multicast UDP packet that is destined for the special link-local multicast address and special destination port noted above.
Network device 102 receives the mDNS announcement and broadcasts (floods) it to all devices in the same local network segment as printer 106(1) (i.e., VLAN 10).
Client 104 receives the mDNS announcement and processes it by creating, in an mDNS cache local to the client, a service record for the printing service identified in the announcement.

One issue with the foregoing mDNS workflows is that they generate a large volume of link-local multicast traffic. For example, as indicated above, when client 104 transmits an mDNS query, network device 102 will flood that query to all devices in VLAN 10. Similarly, when a service device transmits an mDNS announcement, network device 102 will flood that announcement to all devices in VLAN 10. This can lead to various problems related to network reliability, data throughput, capacity, and so on, particularly if network 100 is a wireless network.

To address this issue, FIG. 2 depicts a modified version 200 of network 100 of FIG. 1 that includes, among other things, a novel mDNS flood suppression gateway 202 within network device 102 (referred to as simply mDNS gateway 202). mDNS gateway 202 may be implemented in software, in hardware, or via a combination thereof. For example, in one set of embodiments mDNS gateway 202 may be implemented as a software application that runs on a CPU of network device 102.

With mDNS gateway 202 in place, when network device 102 receives an mDNS message from client 104 or a service device 106, network device 102 can handle the mDNS message in a manner that avoids the need to flood it on VLAN 10. Thus, mDNS gateway 202 can advantageously suppress the local flooding of mDNS traffic and thereby eliminate the problems arising out of such flooding.

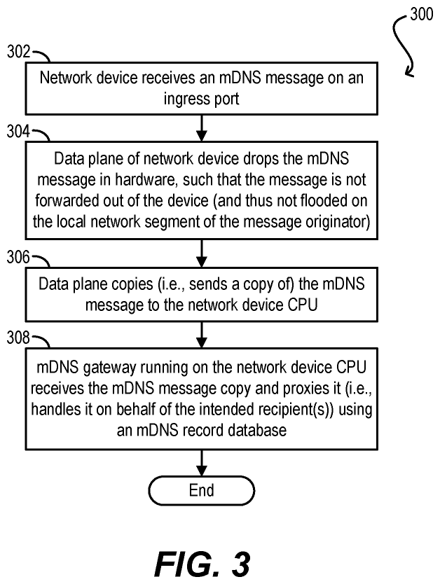

FIG. 3 depicts a high-level workflow 300 that may be executed by network device 102 of FIG. 2 (using its mDNS gateway 202) for suppressing mDNS flooding in accordance with certain embodiments. Starting with block 302, network device 102 can receive an mDNS message on an ingress port of the device. The mDNS message may be an mDNS query message transmitted by client 104 or an mDNS announcement or response message transmitted by a service device 106.

At block 304, the data plane of network device 102 (such as, e.g., a packet processor) can drop the mDNS message at the data plane level (or in other words, in hardware), such that the mDNS message is not forwarded out of the device and thus not flooded on the local network segment of the message originator. The data plane can further send a copy of the mDNS message to the CPU of network device 102 (block 306). These operations are sometimes referred to as “trapping” the message. In certain embodiments, the data plane can carry out blocks 304 and 306 via one or more ternary content-addressable memory (TCAM) entries that are installed in a TCAM of the data plane and are configured to match all incoming mDNS messages (shown in FIG. 2 as mDNS flood suppression TCAM entries 204). Additional details regarding these TCAM entries are provided in sub-section (1.1) below.

Finally, at block 308, mDNS gateway 202 running on the CPU of network device 102 can receive the copy of the mDNS message sent by the data plane and can proxy the mDNS message (or in other words, handle the message on behalf of the intended target client(s) and/or service device(s)) using an mDNS record database (shown via reference numeral 206 in FIG. 2). For example, if the mDNS message is an mDNS announcement, mDNS gateway 202 can create a service record in mDNS record database 206 for the service that the announcement pertains to. This service record can include the information specified in the payload of the mDNS announcement.

As another example, if the mDNS message is an mDNS query, mDNS gateway 202 can process the query by finding service records in mDNS record database 206 that match the parameters specified in the payload of the query (e.g., a particular service type or a particular service name). mDNS gateway 202 can then send out an mDNS response with a payload that includes the matched service records. If the mDNS query had the unicast response bit set, mDNS gateway 202 can send out this mDNS response directly (i.e., via one or more unicast packets) to the query originator. Alternatively, if the mDNS query did not have the unicast response bit set, mDNS gateway 202 can flood this mDNS response on the local network segment of the query originator.

It should be appreciated that FIGS. 1-3 and the foregoing high-level solution description are illustrative and not intended to limit embodiments of the present disclosure. For example, although FIGS. 1 and 2 depict a scenario in which all clients and service devices of network 100 are part of the same local network segment (i.e., VLAN 10), in alternative embodiments the clients and service devices of network 100 may be distributed across multiple different local network segments that are locally connected to network device 102. In these embodiments, mDNS gateway 202 may maintain a segment identifier for each service record held in mDNS record database 206 so that the gateway can keep track of which local network segment the service record belongs to.

Further, although network 200 depicted in FIG. 2 is relatively simple for purposes of illustration, in alternative embodiments mDNS gateway 202 may be implemented in more complex network topologies. For example, in certain embodiments mDNS gateway 202 may be implemented in a network where the clients and service devices include wireless devices that are connected to one or more wireless access points (APs) and where the one or more wireless APs are connected via Virtual Extensible LAN (VXLAN) tunnels to one or more aggregation VXLAN tunnel endpoint (VTEP) switches. An aggregation VTEP switch is a network switch that serves as a virtual tunnel endpoint at the aggregation layer of a network architecture.

In these embodiments, each aggregation VTEP switch can run an instance of mDNS gateway 202 for suppressing the flooding of mDNS messages on the local network segments that are connected to that switch via the VXLAN tunnels. Sub-section (1.5) below describes a network topology comprising multiple interconnected aggregation VTEP switches and the operation of the mDNS gateways running on the switches in this topology. Further, sub-section (1.6) below describes a network topology with a single aggregation VTEP switch composed of a pair of multi-chassis link aggregation group (MLAG) devices, referred to as MLAG peers, and the operation of the mDNS gateways running on the MLAG peers in this topology.

### 1.1 TCAM Setup

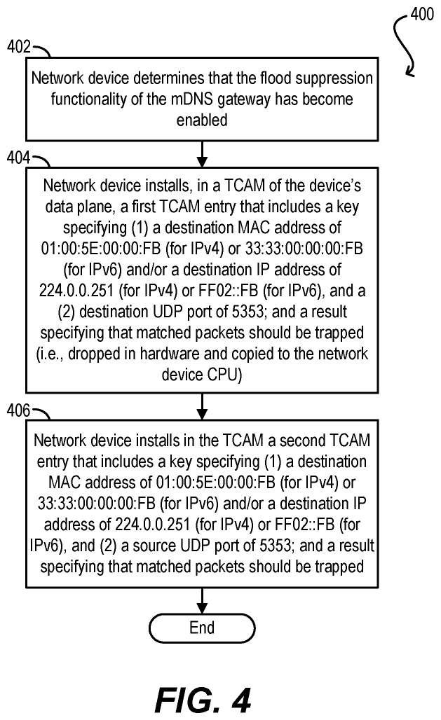

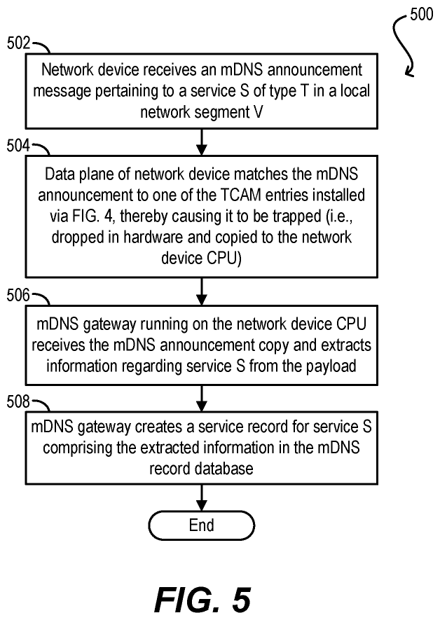

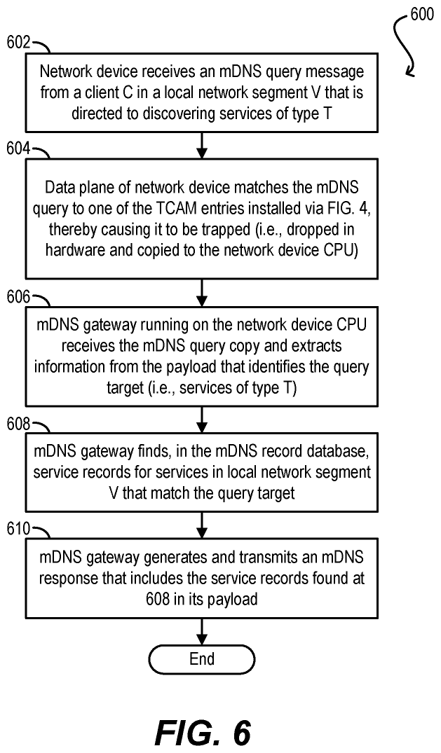

FIG. 4 depicts a workflow 400 that may be executed by network device 102 of FIG. 2 for installing mDNS flood suppression TCAM entries 204 into the device's data plane according to certain embodiments, thereby configuring the data plane to trap incoming mDNS messages.

Starting with block 402, network device 102 can determine that the flood suppression functionality of mDNS gateway 202 has become enabled. This may occur in response to a user command to enable such functionality or upon device boot up/initialization (if mDNS gateway 202 is automatically turned on at that time).

Upon determining that mDNS flood suppression is enabled, network device 102 can install, in a TCAM of the device's data plane, a first TCAM entry that includes a key (i.e., packet match criteria) specifying (1) a destination MAC address corresponding to a special link-local multicast MAC address (01:00:5E:00:00:FB for IPV4 and 33:33:00:00:00:FB for IPV6) and/or a destination IP address corresponding to a special link-local multicast IP address (224.0.0.251 for IPv4 and FF02::FB for IPV6), and (2) a destination UDP port of 5353. In addition, the first TCAM entry can include a result (i.e., action to be taken on packets that match the key) specifying that matched packets should be trapped, or in other words dropped in the data plane and copied to the network device's CPU (block 404). Network device 102 can also install in the TCAM a second TCAM entry that includes a key specifying (1) a destination MAC address corresponding the special link-local multicast MAC address (01:00:5E:00:00:FB for IPV4 and 33:33:00:00:00:FB for IPV6) and/or a destination IP address corresponding to the special link-local multicast IP address (224.0.0.251 for IPV4 and FF02::FB for IPV6), a (2) source UDP port of 5353. In addition, the second TCAM entry can include a result specifying that matched packets should be trapped (block 406).

Because mDNS query, announcement, and response messages all specify a destination MAC address of 01:00:5E:00:00:FB or 33:33:00:00:00:FB, a destination IP address of 224.0.0.251 or FF02::FB, a source UDP port of 5353, and/or a destination UDP port of 5353 in accordance with the mDNS standard, the installation of these two TCAM entries ensures that all mDNS messages arriving at network device 102 are trapped to the device CPU and not flooded out on the local network segments they originated from.

1.2 mDNS Announcement Workflow with mDNS Flood Suppression Enabled

FIG. 5 depicts a workflow 500 that may be executed by network device 102 of FIG. 2 for handling mDNS announcement messages when the flood suppression functionality of mDNS gateway 202 is enabled according to certain embodiments.

Starting with block 502, network device 102 can receive an mDNS announcement pertaining to a service S in a local network segment (e.g., VLAN) V, where service S is of a service type T. For example, the mDNS announcement may have been sent by printer 106(1) of VLAN 10 in order to announce the availability of the printing service of that printer.

At block 504, the data plane of network device 102 can match the mDNS announcement to one of the TCAM entries installed via workflow 400, thereby causing the announcement to be dropped in hardware (such that it is not flooded on local network segment V) and a copy of the mDNS announcement to be sent to the network device CPU.

At block 506, mDNS gateway 202 can receive the copy of the mDNS announcement and can extract information pertaining to service S from the payload of that copy. This information can include, e.g., the name of service S, the IP address of service S, the type of service S (i.e., type T), and so on.

Finally, at block 508, mDNS gateway 202 can create a service record for service S comprising the extracted information in mDNS record database 206 and the workflow can end.

1.3 mDNS Query Workflow with mDNS Flood Suppression Enabled

FIG. 6 depicts a workflow 600 that may be executed by network device 102 of FIG. 2 for handling mDNS query messages when the flood suppression functionality of mDNS gateway 202 is enabled according to certain embodiments.

Starting with block 602, network device 102 can receive an mDNS query from a client C in a local network segment V, where the mDNS query is directed to discovering services of type T. For example, the mDNS query may have been sent by client 104 in order to find printing services on VLAN 10.

At block 604, the data plane of network device 102 can match the mDNS query to one of TCAM entries 204, thereby causing the query to be dropped in hardware (such that it is not flooded to local network segment V) and causing a copy of the mDNS query to be sent to the network device CPU.

At block 606, mDNS gateway 202 can receive the copy of the mDNS query and extract information from the payload of that copy identifying the query target (i.e., services of type T). mDNS gateway 202 can then find, in mDNS record database 206, service records for services in local network segment V (i.e., the local network segment of client C) that match the query target (block 608).

Finally, at block 610, mDNS gateway 202 can generate and transmit an mDNS response that includes, in its payload, the service records found at block 608. If the mDNS query received at block 602 had the unicast response bit set, mDNS gateway 202 can transmit the mDNS response as a unicast packet directly to client C. Alternatively, if the mDNS query did not have the unicast response bit set, mDNS gateway 202 can flood the mDNS response as a multicast packet on local network segment V.

### 1.4 Active Service Discovery and Record Maintenance

In some scenarios, network device 102 may fail to receive mDNS announcements that are sent by one or more service devices 106 for various reasons (temporary network disruption, network configuration issues, etc.). This means that mDNS gateway 202 will not have service records for the services of those service devices in mDNS record database 206 and thus will not be able to correctly handle mDNS queries directed to those services.

To address this problem, in certain embodiments mDNS gateway 202 can implement an active service discovery mechanism that involves periodically sending out mDNS queries (with the unicast response bit set) on all of the local network segments connected to network device 102. This will cause service devices on those segments to return unicast mDNS responses to mDNS gateway 202 regarding their respective services, which the gateway can use to populate mDNS record database 206. In a particular embodiment, mDNS gateway 202 may implement this active service discovery mechanism only for services identified in a user-defined list, thereby limiting the amount of mDNS traffic generated by the mechanism.

In addition, to prevent mDNS record database 206 from becoming stale, in certain embodiments mDNS gateway 202 can maintain, for each service record in the database, a timer that is set to run for a predefined time-to-live (TTL) period (e.g., 60 minutes). When the timer for a given service record has elapsed, mDNS gateway can transmit a “keep alive” mDNS query (with the unicast response bit set) to the service device providing that service. If mDNS gateway 202 receives an mDNS response from the service device in response to the keep alive mDNS query, the gateway can determine that the service is still alive and can reset the service's associated timer. However, if the mDNS gateway 202 does not receive an mDNS response from the service device within a threshold period of time, the gateway can determine that the service is no longer available and can remove the service record for the service from mDNS record database 206.

1.5 mDNS Gateway Implementation on Multiple Aggregation VTEP Switches

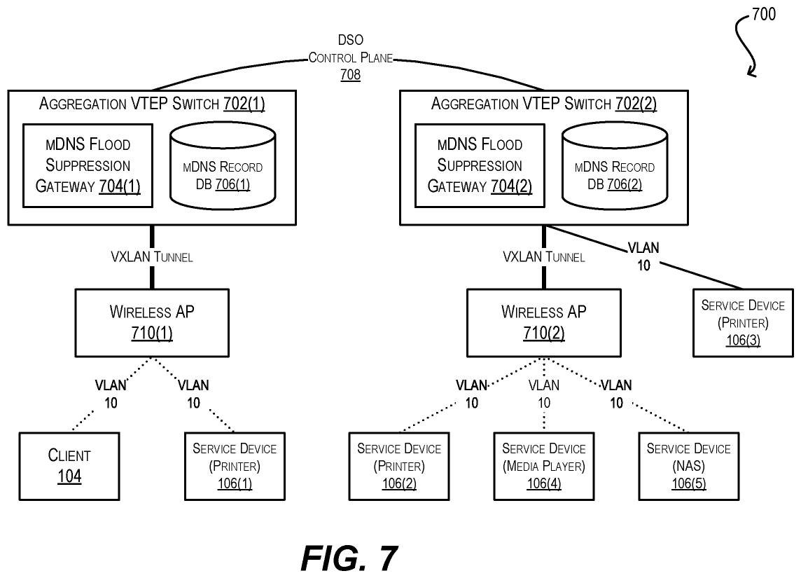

As mentioned previously, in some embodiments the mDNS gateway of the present disclosure may be implemented on one or more aggregation VTEP switches that are connected to wireless clients and wireless service devices via one or more wireless APs. For example, FIG. 7 depicts a network 700 that comprises two aggregation VTEP switches 702(1) and 702(2), each including an mDNS gateway 704 and an mDNS record database 706.

As shown, aggregation VTEP switches 702(1) and 702(2) are connected to each other via a DNS Stateful Operation (DSO) control plane 708. In addition, aggregation VTEP switches 702(1) and 702(2) are connected via VXLAN tunnels to wireless APs 710(1) and 710(2) respectively, each of which is in turn wirelessly connected to a subset of the client/service devices of VLAN 10 described in the prior sections. These wireless connections are depicted via dotted lines. For example, wireless AP 710(1) is wirelessly connected to client 104 and printer 106(1) while wireless AP 710(2) is wirelessly connected to printer 106(2), digital media player 106(4), and NAS 106(5). In addition, aggregation VTEP switch 702(2) is locally connected (via, e.g., a front panel interface) to printer 106(3).

In accordance with the present disclosure, each wireless AP 710 has local flooding disabled, or in other words is configured to tunnel all broadcast, unknown unicast, and multicast (BUM) traffic received from wirelessly connected endpoints to its corresponding aggregation VTEP switch 702 over the VXLAN tunnel, rather than flooding that traffic back on its wireless medium. If the wireless AP receives BUM traffic from the other direction (i.e., from the aggregation VTEP switch), it will flood that traffic on its wireless medium.

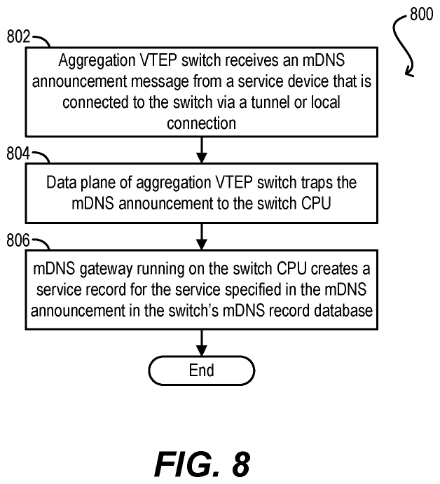

With the foregoing in mind, FIG. 8 depicts a workflow 800 indicating how each aggregation VTEP switch 702 can handle mDNS announcements when the flood suppression functionality of its mDNS gateway 704 is enabled according to certain embodiments. Workflow 800 assumes that each aggregation VTEP switch 702 has installed mDNS flood suppression TCAM entries 204 in its data plane for trapping mDNS messages per workflow 400 of FIG. 4.

Starting with block 802, the aggregation VTEP switch can receive an mDNS announcement from a service device that is connected to the switch via a tunnel or a local (e.g., front panel interface) connection.

At block 804, the data plane of the aggregation VTEP switch can trap the mDNS announcement to the switch CPU in a manner similar to block 504 of workflow 500. The switch's mDNS gateway can then create a service record for the service specified in the mDNS announcement in its local mDNS record database in a manner similar to blocks 506 and 508 of workflow 500 (block 806).

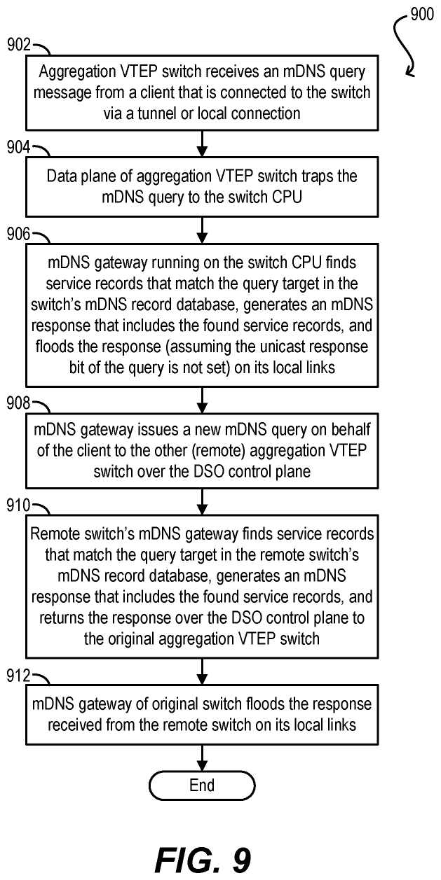

Further, FIG. 9 depicts a workflow 900 indicating how each aggregation VTEP switch 702 can handle mDNS queries when the flood suppression functionality of its mDNS gateway 704 is enabled according to certain embodiments. It should be noted that, because of the mDNS announcement handling logic shown in workflow 800, each aggregation VTEP switch 702 will only learn (i.e., create local service records for) services that are connected to that particular switch via a tunnel or a local connection. For example, mDNS gateway 704(1) of aggregation VTEP switch 702(1) will not create local service records for mDNS announcements generated by service devices 106(2)-(5) because those services devices are connected to aggregation VTEP switch 702(2) and thus their announcements will never reach aggregation VTEP switch 702(1). Similarly, mDNS gateway 704(2) of aggregation VTEP switch 702(2) will not create a local service record for an announcement generated by service device 106(1) because that service device is connected to aggregation VTEP switch 702(1) and thus its announcement will never reach aggregation VTEP switch 702(2). Workflow 900 takes this into account by forwarding mDNS queries over DSO control plane 708, thereby ensuring that all relevant service records targeted by an mDNS query are found. For example, assume mDNS gateway 704(2) of aggregation VTEP switch 702(2) holds local service records for printers 106(2) and 106(3), and further assume client 104 (which is connected to aggregation VTEP switch 702(1)) issues an mDNS query for printing services. In this scenario, via the functionality shown in workflow 900, the query will be received by aggregation VTEP switch 702(1) and forwarded to aggregation VTEP switch 702(2) over DSO control plane 708, thereby ensuring that the service records for printers 106(2) and 106(3) are retrieved by mDNS gateway 704(2) and returned to the client.

Starting with block 902, the aggregation VTEP switch can receive an mDNS query from a client that is connected to the switch via a tunnel or a local (e.g., front panel interface) connection.

At block 904, the aggregation VTEP switch can trap the mDNS query to the switch CPU in a manner similar to block 604 of workflow 600. The switch's mDNS gateway can then find service records that match the query target in its local mDNS record database, generate an mDNS response that includes the found service records, and flood the response (assuming the query's unicast response bit was not set) on its front panel interface connections (which include the VXLAN tunnel(s) to wireless AP(s)) (block 906).

In addition, the mDNS gateway can issue a new mDNS query on behalf of the client to the other (i.e., remote) aggregation VTEP switch over DSO control plane 708, where the new mDNS query is identical or substantially similar to the original mDNS query (block 908). In response to this new mDNS query, the remote switch's mDNS gateway can find matching service records in its local mDNS record database, generate an mDNS response that includes the matched service records, and return the response over DSO control plane 708 to the original aggregation VTEP switch (block 910).

Finally, the mDNS gateway of the original aggregation VTEP switch can flood the mDNS response from the remote aggregation VTEP switch on its front panel interface connections (which include the VXLAN tunnel(s) to wireless AP(s)) (block 912) and the workflow can end.

1.6 mDNS Gateway Implementation on a Single Aggregation VTEP Switch Using MLAG

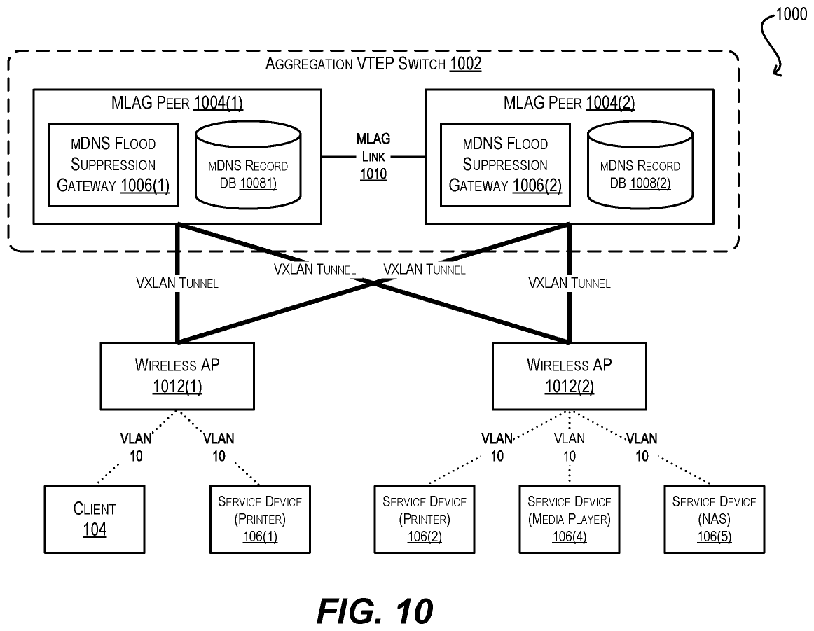

As another alternative network topology, FIG. 10 depicts a network 1000 comprising a single logical aggregation VTEP switch 1002 that is composed of two MLAG peers 1004(1) and 1004(2) for redundancy. Each MLAG peer 1004 includes an mDNS gateway 1006 and an mDNS record database 1008.

As shown, MLAG peers 1004(1) and 1004(2) are connected to each other via an MLAG link 1010. In addition, MLAG peers 1004(1) and 1004(2) are connected via VXLAN tunnels to wireless APs 1012(1) and 1012(2) respectively using multihoming, and each wireless AP 1012 is in turn wirelessly connected to a subset of the client/service devices of VLAN 10 described in the prior sections. These wireless connections are depicted via dotted lines. For example, wireless AP 1012(1) is wirelessly connected to client 104 and printer 106(1), while wireless AP 1012(2) is wirelessly connected to printer 106(2), digital media player 106(4), and NAS 106(5).

Like network 700 of FIG. 7, each wireless AP 1012 has local flooding disabled, or in other words is configured to tunnel all broadcast, unknown unicast, and multicast (BUM) traffic received from wirelessly connected endpoints to MLAG peers 1004(1) and 1004(2) over the VXLAN tunnels, rather than flooding that traffic back on its wireless medium. If the wireless AP receives BUM traffic from the other direction (i.e., from an MLAG peer), it will flood that traffic on its wireless medium.

Generally speaking, the process performed by each MLAG peer 1004 for handling mDNS announcements with mDNS flood suppression enabled can be similar to workflow 500 of FIG. 5. However, because of the MLAG configuration, it is possible for (1) an mDNS announcement for a service S to be sent to one MLAG peer, and (2) an mDNS query for that same service S to be sent to the other MLAG peer. In this scenario, the MLAG peer that receives the mDNS query will not have the appropriate service record for the queried service in its local mDNS record database.

One solution for this problem is for mDNS gateways 1006(1) and 1006(2) on MLAG peers 1004(1) and 1004(2) to periodically synchronize their respect mDNS record databases 1008(1) and 1008(2) over MLAG link 1010. This will ensure that all service records are available on both MLAG peers.

Another solution is for the MLAG peers to implement an mDNS query handling workflow that is similar to workflow 900 of FIG. 9. In particular, upon receiving an mDNS query at a first MLAG peer, the mDNS gateway of the first MLAG peer can process the query against its local mDNS record database and also issue a new query on behalf of the client over MLAG link 1010 to the second MLAG peer. The mDNS gateway of the second MLAG peer can then process this query against its local mDNS record database and return an mDNS response to the original MLAG peer for flooding on the original MLAG peer's front panel connections.

### 2. DHCP Flood Suppression

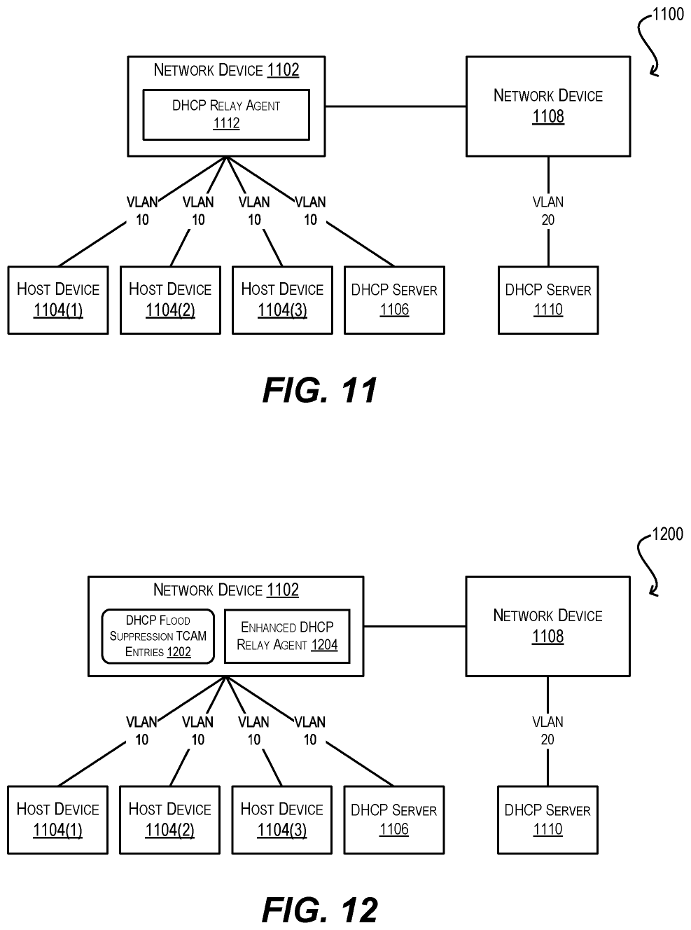

FIG. 11 depicts an example network 1100 in which the DHCP flood suppression techniques of the present disclosure may be implemented. As shown, network 1100 includes a first network device (e.g. switch) 1102 that is locally connected to a set of host devices 1104(1)-(3) and a first DHCP server 1106, and a second network device (e.g., switch) 1108 that is locally connected to a second DHCP server 1110. Host devices 1104(1)-(3) and DHCP server 1106 are part of a first local network segment managed by network device 1102 (i.e., VLAN 10), and DHCP server 1110 is part of a second local network segment managed by network device 1108 (i.e., VLAN 20). In addition, network devices 1102 and 1108 are interconnected, thereby enabling the endpoints in VLANs 10 and 20 to communicate with each other. For example, traffic originating from an endpoint in VLAN 10 and destined for an endpoint in VLAN 20 will be received at network device 1102 and routed through network device 1108 to its destination. Similarly, traffic originating from an endpoint in VLAN 20 and destined for an endpoint in VLAN 10 will be received at network device 1108 and routed through network device 1102 to its destination.

In FIG. 11, it is assumed that host devices 1104(1)-(3) in VLAN 10 are configured to use DHCP in order to obtain IP addresses from DHCP servers such as 1106 and 1110. As mentioned previously, DHCP is a networking protocol defined in RFC 2131, RFC 3315, and RFC 8415 that leverages broadcast (in the case of DHCPv4) or link-local multicast (in the case of DHCPv6) to enable dynamic IP address assignment. DHCPv4 is the version of DHCP used in IPv4 networks and DHCPv6 is the version of DHCP used in IPV6 networks. To clarify how DHCP operates, the following is an example DHCP workflow that may be executed for assigning an IP address to host device 1104(1) of FIG. 1. In this workflow, host device 1104(1) is referred to as a DHCP client. Host device 1104(1) may initiate the workflow at, for example, the time it connects to network 1100.
Host device 1104(1) transmits a DHCP discover (DHCPv4) or solicit (DHCPv6) message with a payload comprising a request to find available DHCP servers. For DHCPv4, the discover message takes the form of a broadcast UDP packet that specifies a source port of 68 (which is a special port used by DHCPv4 clients), a destination IP address of 255.255.255.255 (which is a special IPv4 broadcast address), and a destination port of 67 (which is a special port used by DHCPv4 servers and relay agents). The discover message also includes a broadcast flag that indicates whether the receiving DHCP server's response to the discover message should be broadcast or unicast. For DHCPv6, the solicit message takes the form of a link-local multicast UDP packet that specifies source port of 546 (which is a special port used by DHCPv6 clients), a destination IP address of ff02::1:2 (which is a special IPv6 link-local multicast address), and a destination port of 547 (which is a special port used by DHCPv6 servers and relay agents).
Network device 1102 receives the DHCP discover/solicit message and broadcasts (floods) it to all endpoints in the same local network segment as the DHCP client (i.e., VLAN 10). In addition, a DHCP relay agent 1112 running on the CPU of network device 1102, which is aware of the existence of DHCP server 1110 in VLAN 20, forwards the message via unicast to DHCP server 1110. This unicast message is routed through network device 1108.
DHCP server 1106 in VLAN 10 receives the DHCP discover/solicit message flooded by network device 1102 and responds by transmitting a DHCP offer (DHCPv4) or advertise (DHCPv6) message with a payload comprising an offered IP address and other related network configuration information. For DHCPv4, if the broadcast flag in the discover message was set, the offer message takes the form of a broadcast UDP packet that specifies a source port of 67, a destination IP address of 255.255.255.255, and a destination port of 68; if the broadcast flag was not set, the offer message takes the form of a unicast UDP packet that specifies a source port of 67, a destination IP address specifying the IP address of host device 1104(1), and a destination port of 68. For DHCPv6, the advertise message takes the form of a link-local multicast UDP packet that specifies a source port of 547, a destination IP address of ff02::1:2, and a destination port of 546.
DHCP server 1110 in VLAN 20 receives the DHCP discover/solicit message forwarded by DHCP relay agent 1112 and responds by transmitting a DHCP offer (DHCPv4) or advertise (DHCPv6) message with a payload comprising an offered IP address and other related network configuration information. For DHCPv4, the offer message takes the form of a unicast UDP packet that specifies a source port of 67, a destination IP address specifying the IP address of DHCP relay agent 1112, and a destination port of 67. This offer message also includes the value of the broadcast flag included in the discover message. For DHCPv6, the advertise message takes the form of a unicast UDP packet that specifies a source port of 547, a destination IP address specifying the IP address of DHCP relay agent 1112, and a destination port of 547.
Network device 1102 receives the DHCP offer/advertise message transmitted by DHCP server 1106 and floods it to all endpoints in VLAN 10 (if it is a broadcast/multicast packet) or forwards it directly to host device 1104(1) (if it is a unicast packet). Similarly, DHCP relay agent 1112 receives the DHCP offer/advertise message transmitted by DHCP server 1110 and floods it to all endpoints in VLAN 10 (if the broadcast flag is set) or forwards it directly to host device 1104(1) (if the broadcast flag is not set).
Host device 1104(1) receives the DHCP offer/advertise messages from DHCP servers 1106 and 1110, selects one of the offers, and responds with a DHCP request message comprising a payload that identifies the selected offer (for this example, assume the selected offer is the one provided by DHCP server 1110). For DHCPv4, the request message takes the form of a broadcast UDP packet that specifies a source port of 68, a destination IP address of 255.255.255.255, and a destination port of 67. The DHCPv4 request message also includes a broadcast flag indicating whether the selected DHCP server's response to the request message should be broadcast or unicast. For DHCPv6, the request message takes the form of a link-local multicast UDP packet that specifies source port of 546, a destination IP address of ff02::1:2, and a destination port of 547.
Network device 1102 receives the DHCP request message and floods it to all endpoints in the same local network segment as the DHCP client (i.e., VLAN 10). In addition, DHCP relay agent 1112 forwards the message via unicast to DHCP server 1110.
DHCP server 1106 in VLAN 10 receives the DHCP request message flooded by network device 1102 and takes no further action (because its offer was not selected).
DHCP server 1110 in VLAN 20 receives the DHCP request message forwarded by DHCP relay agent 1112 and responds by transmitting a DHCP ack (DHCPv4) or reply (DHCPv6) message with a payload comprising an acknowledgment that the offered IP address has been accepted. For DHCPv4, the ack message takes the form of a unicast UDP packet that specifies a source port of 67, a destination IP address specifying the IP address of DHCP relay agent 1112, and a destination port of 67. This ack message also includes the value of the broadcast flag included in the request message. For DHCPv6, the reply message takes the form of a unicast UDP packet that specifies a source port of 547, a destination IP address specifying the IP address of DHCP relay agent 1112, and a destination port of 547.
Finally, DHCP relay agent 1112 receives the DHCP ack/reply message transmitted by DHCP server 1110 and floods it to all endpoints in VLAN 10 (if the broadcast flag is set) or forwards it directly to host device 1104(1) (if the broadcast flag is not set). In either case, the ack/reply message is received by host device 1104(1) and the workflow ends.

As can be seen from the example workflow above, DHCP generates a large amount of link-local multicast or broadcast traffic, particularly with respect to messages sent to the DHCP servers. Thus, like mDNS, this excess multicast/broadcast traffic can cause issues with network throughput, capacity, reliability, and so on.

To address the foregoing, FIG. 12 depicts a modified version 1200 of network 1100 of FIG. 11 that implements a novel DHCP flood suppression mechanism comprising a set of DHCP flood suppression TCAM entries 1202 and an enhanced DHCP relay agent 1204 in network device 1102. As detailed in subsections (2.1) and (2.2) below, when network device 1102 of FIG. 12 receives a DHCP discover/solicit or request message from a host device 1104, the data plane of the network device can match the message to one of TCAM entries 1202, which are designed to drop the message in hardware (such that it is not flooded out on the local network segment of the message originator) and to copy the message to the device CPU. Enhanced DHCP relay agent 1204 running on the CPU can then directly forward the message to the DHCP servers known to (or in other words, configured on) agent 1204. For example, enhanced DHCP relay agent 1204 can forward the message via unicast to both DHCP server 1106 (which resides in the same VLAN as the message originator) and to DHCP server 1110 (which resides in a different VLAN). In this way, the mechanism shown in FIG. 12 can advantageously avoid the need to flood such DHCP messages and thereby eliminate the problems arising out of such flooding.

It should be appreciated that FIGS. 11 and 12 and the foregoing high-level description of the DHCP flood suppression mechanism are illustrative and not intended to limit embodiments of the present disclosure. For example, in some embodiments network device 1102 may implement a local DHCP server that runs on the device itself (e.g., as software that runs on the device CPU). In these embodiments, as part of processing a received DHCP discover/solicit or request message, enhanced DHCP relay agent 1204 may deliver the message to the local DHCP server, in addition to transmitting the message via unicast to other DHCP servers in the same or different local network segments as the message originator.

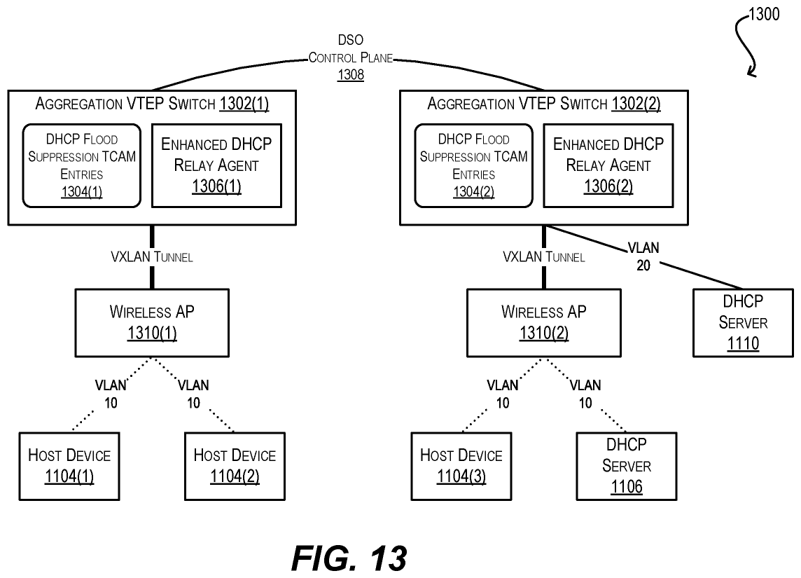

Further, like the mDNS embodiments described previously, the DHCP flood suppression mechanism can be implemented in more complex network topologies. For example, FIG. 13 depicts a network 1300 that comprises two aggregation VTEP switches 1302(1) and 1302(2), each including a set of DHCP flood suppression TCAM entries 1304 and an enhanced DHCP relay agent 1306.

As shown in FIG. 13, aggregation VTEP switches 1302(1) and 1302(2) are connected to each other via a DNS Stateful Operation (DSO) control plane 1308. In addition, these switches are connected via VXLAN tunnels to wireless APs 1310(1) and 1310(2) respectively, each of which is in turn wirelessly connected to a subset of the endpoints in VLAN 10 from FIGS. 11 and 12. For example, AP 1310(1) is wirelessly connected to host devices 1104(1) and 1104(2) and AP 1310(2) is wirelessly connected to host device 1104(3) and DHCP server 1106. In addition, aggregation VTEP switch 1302(2) is locally connected (via, e.g., a front panel interface) to DHCP server 1110 in VLAN 20.

In network 1300, the DHCP flood suppression mechanism implemented in each aggregation VTEP switch 1302 will generally operate in a similar manner as discussed for network 1200 of FIG. 12. For example, assume host device 1104(1) broadcasts a DHCP discover message for finding DHCP servers. In this case the message will be forwarded by wireless AP 1310(1) to aggregation VTEP switch 1302(1), which will trap the message to the switch CPU in accordance with its DHCP flood suppression TCAM entries 1304(1). Enhanced DHCP relay agent 1306(1) will then process the message by forwarding it via unicast to the DHCP servers it is aware of (e.g., DHCP servers 1106 and 1110), thereby avoiding flooding of the message on VLAN 10 of host device 1104(1).

### 2.1 TCAM Setup

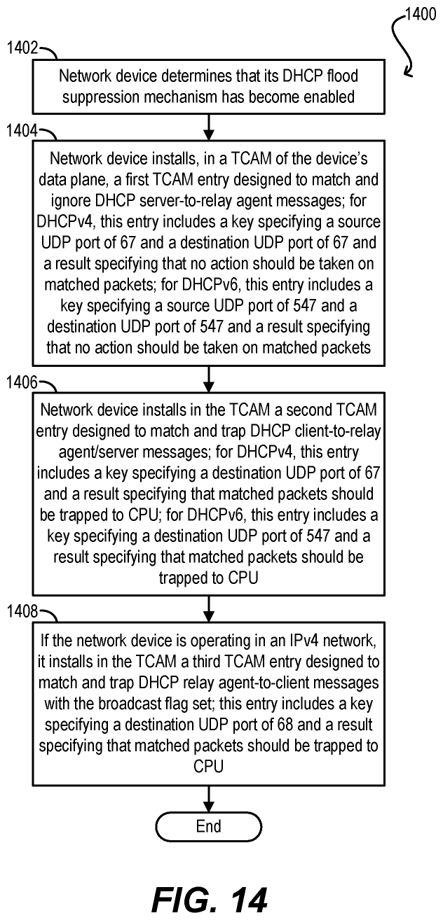

FIG. 14 depicts a workflow 1400 that may be executed by network device 1102 of FIG. 12 for installing DHCP flood suppression TCAM entries 1202 into the device's data plane according to certain embodiments, thereby configuring the data plane to trap certain incoming DHCP messages.

Starting with block 1402, network device 1102 can determine that its DHCP flood suppression mechanism has become enabled. This may occur in response to a user command to enable the mechanism or upon device boot up/initialization.

Upon determining that DHCP flood suppression is enabled, network device 1102 can install, in a TCAM of the device's data plane, a first TCAM entry that is designed to match and ignore DHCP server-to-relay agent messages (e.g., unicast offer/advertise and ack/reply messages) because those messages are not broadcast or multicast messages and thus should not be suppressed (block 1404). For DHCPv4, this first TCAM entry can include a key specifying a source UDP port of 67 and a destination UDP port of 67 and a result specifying that no action should be taken on matched packets. For DHCPv6, this first TCAM entry can include a key specifying a source UDP port of 547 and a destination UDP port of 547 and a result specifying that no action should be taken on matched packets.

Network device 1102 can further install a second TCAM entry with a lower priority than the first TCAM entry that is designed to match DHCP client-to-relay agent/server messages (e.g., broadcast or multicast discover/solicit and request messages) and to trap those messages to the device CPU for handling by enhanced DHCP relay agent 1204 (block 1406). For DHCPv4, this second TCAM entry can include a key specifying a destination UDP port of 67 and a result specifying that matched packets should be trapped. For DHCPv6, this second TCAM entry can include a key specifying a destination UDP port of 547 and a result specifying that matched packets should be trapped.

Finally, if the network in which network device 1102 operates is an IPv4 network, the device can install a third TCAM entry that is specific to DHCPv4 and is designed to match DHCP relay agent-to-client messages with the broadcast flag set (e.g., broadcast offer and ack messages) and to trap those messages to the device CPU for handling by enhanced DHCP relay agent 1204 (block 1408). The purpose of this third TCAM entry is to prevent the propagation of such broadcast messages in edge cases where the network device that is receiving them is not locally connected to the DHCP client. The entry can include a key specifying a destination UDP port of 68 and a result specifying that matched packets should be trapped.

2.2 DHCP Discover/Solicit and Request Handling with DHCP Flood Suppression Enabled

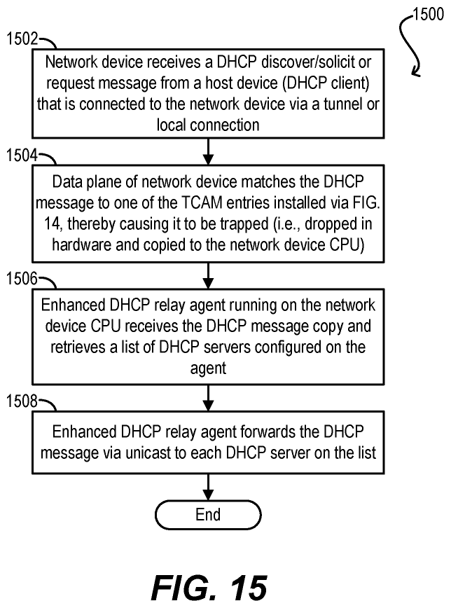

FIG. 15 depicts a workflow 1500 that may be executed by network device 1102 of FIG. 12 for handling DHCP discover/solicit and request messages when DHCP flood suppression is enabled on the device according to certain embodiments.

Starting with block 1502, network device 1102 can receive a DHCP discover/solicit or request message from a host device (DHCP client) that is connected to network device 1102 (either via a local connection or through a wireless AP and VXLAN tunnel in accordance with topology shown in FIG. 13).

At block 1504, the data plane of network device 1102 can match the DHCP message to one of the TCAM entries installed via workflow 1400, thereby causing the message to be dropped in hardware (such that it is not flooded on the DHCP client's local network segment) and a copy of the message to be sent to the network device CPU.

At block 1506, enhanced DHCP relay agent 1204 can receive the copy of the DHCP message and retrieve a list of DHCP servers that are configured on the agent. This can include DHCP servers that are in the same local network segment as the DHCP client, in a different local network segment, and/or a DHCP server that is running on network device 1102 itself.

Finally, at block 1508, enhanced DHCP relay agent 1204 can forward the DHCP message via unicast to each DHCP server in the list and the workflow can end.

### 3. Example Network Device

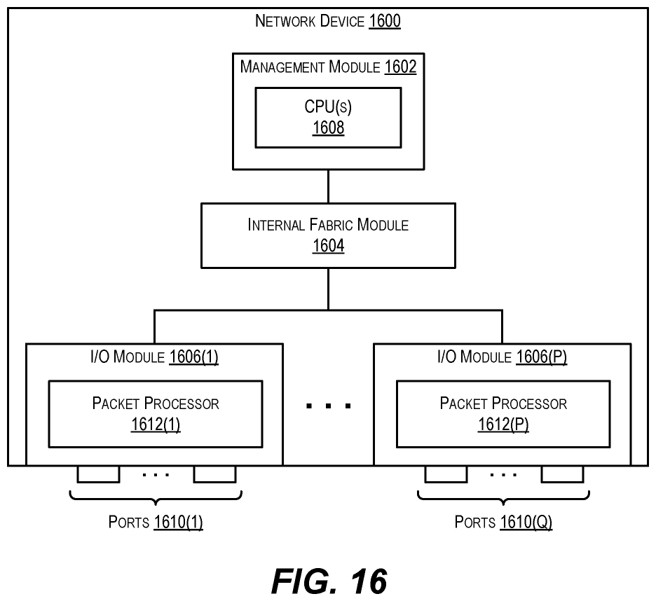

FIG. 16 depicts an example network device 1600 according to certain embodiments of the present disclosure. Network device 1600 may be used to implement any of the network devices described in the preceding sections.

As shown, network device 1600 includes a management module 1602, an internal fabric module 1604, and a number of I/O modules 1606(1)-(P). Management module 1602 includes one or more management CPUs 1608 for managing/controlling the operation of the device. Each management CPU 1608 can be a general purpose processor, such as an Intel/AMD x86 or ARM-based processor, that operates under the control of software stored in an associated memory (not shown). In certain embodiments, the mDNS gateway of the present disclosure may be executed wholly, or in part, by management CPUs 1608.

Internal fabric module 1604 and I/O modules 1606(1)-(P) collectively represent the data, or forwarding, plane of network device 1600. Internal fabric module 1604 is configured to interconnect the various other modules of network device 1600. Each I/O module 1606 includes one or more input/output ports 1610(1)-(Q) that are used by network device 1600 to send and receive network packets. Each I/O module 1606(1)-(P) can also include a packet processor 1612. Packet processor 1612 is a hardware processing component (e.g., an application specific integrated circuit (ASIC) or field-programmable gate array (FPGA)) that can make wire speed decisions on how to handle incoming or outgoing network packets. In certain embodiments, the TCAM entries described in the present disclosure may be installed in a TCAM that is part of, communicatively coupled with, one or more packet processors 1612(1)-(P).

It should be appreciated that network device 1600 is illustrative and many other configurations having more or fewer components than network device 1600 are possible.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device for suppressing flooding of link-local multicast or broadcast traffic, the method comprising:
receiving a link-local multicast or broadcast message from an endpoint that is connected to the network device, the endpoint being part of a local network segment;
dropping, by a data plane of the network device, the link-local multicast or broadcast message in hardware, such that the link-local multicast or broadcast message is not flooded on the local network segment;
copying, by the data plane, the link-local multicast or broadcast message to a central processing unit (CPU) of the network device; and
processing, by a software component running on the CPU, the link-local multicast or broadcast message received from the data plane.

2. The method of claim 1 wherein the dropping and the copying are performed by the data plane using one or more ternary-content addressable memory (TCAM) entries.

3. The method of claim 1 wherein the link-local multicast or broadcast message is a Dynamic Host Configuration Protocol (DHCP) message originating from a host device in the local network segment, wherein the software component running on the CPU is an enhanced DHCP relay agent, and wherein the processing performed by the enhanced DHCP relay agent on the DHCP message comprises forwarding the DHCP message to a DHCP server via unicast.

4. The method of claim 3 wherein the DHCP server resides on a different local network segment than the host device.

5. The method of claim 3 wherein the DHCP server resides on the local network segment.

6. The method of claim 3 wherein the DHCP server runs on the CPU of the network device.

7. The method of claim 3 wherein the dropping and the copying are performed by the data plane using a set of TCAM entries that includes:
a first TCAM entry with a key field specifying a source User Datagram Protocol (UDP) port of 67 and a destination UDP port of 67 and an action field specifying that no action should be taken; and
a second TCAM rule with a key field specifying a destination UDP port of 67 and an action field specifying that matched packets should be dropped in hardware and copied to the CPU.

8. The method of claim 7 wherein the set of TCAM entries further includes a third TCAM entry with a key field specifying a destination UDP port of 68 and an action field specifying that matched packets should be dropped in hardware and copied to the CPU.

9. The method of claim 3 wherein the dropping and the copying are performed by the data plane using a set of TCAM entries that includes:
a first TCAM entry with a key field specifying a source UDP port of 547 and a destination UDP port of 547 and an action field specifying that no action should be taken; and
a second TCAM rule with a key field specifying a destination UDP port of 547 and an action field specifying that matched packets should be dropped in hardware and copied to the CPU.

10. The method of claim 1 wherein the link-local multicast or broadcast message is a multicast Domain Name System (mDNS) announcement originating from a service device in the local network segment or an mDNS query originating from a client in the local network segment, and wherein the software component running on the CPU is an mDNS gateway.

11. The method of claim 10 wherein the processing performed by the mDNS gateway on the mDNS announcement comprises:
extracting information regarding the service from the mDNS announcement; and
creating a service record including the extracted information in an mDNS record database residing on the network device.

12. The method of claim 10 wherein the processing performed by the mDNS gateway on the mDNS query comprises:
matching the mDNS query to one or more service records in a mDNS record database residing on the network device;
generating an mDNS response that includes the one or more service records; and
transmitting the mDNS response.

13. The method of claim 10 wherein the mDNS query includes a setting indicating that responses to the mDNS query should be unicast, and wherein the mDNS response is transmitted directly to the client via a unicast packet.

14. The method of claim 10 wherein the mDNS query does not include a setting indicating that responses to the mDNS query should be unicast, and wherein the mDNS response is flooded on the local network segment.

15. The method of claim 10 wherein the dropping and the copying are performed by the data plane using a set of TCAM entries that includes:
a first TCAM entry with:
a key field specifying a destination MAC address of 01:00:5E:00:00:FB and/or a destination IP address of 224.0.0.251, and a destination User Datagram Protocol (UDP) port of 5353; and
an action field specifying that the broadcast or multicast message should be dropped in hardware and copied to the CPU; and
a second TCAM entry with:
a key field specifying a destination MAC address of 01:00:5E:00:00:FB and/or a destination IP address of 224.0.0.251, and a source User Datagram Protocol (UDP) port of 5353, and
an action field specifying that matched packets should be dropped in hardware and copied to the CPU.

16. The method of claim 10 wherein the dropping and the copying are performed by the data plane using a set of TCAM entries that includes:
a first TCAM entry with:
a key field specifying a destination MAC address of 33:33:00:00:00:FB and/or a destination IP address of FF02::FB, and a destination User Datagram Protocol (UDP) port of 5353, and
an action field specifying that matched packets should be dropped in hardware and copied to the CPU; and
a second TCAM rule with:
a key field specifying a destination MAC address of 33:33:00:00:00:FB and/or a destination IP address of FF02::FB, and a source User Datagram Protocol (UDP) port of 5353, and
an action field specifying that matched packets should be dropped in hardware and copied to the CPU.

17. A network device comprising:
a plurality of ports;
a data plane; and
a central processing unit (CPU),
wherein the network device is configured to:
receive a link-local multicast or broadcast message from an endpoint that is connected to the network device, the endpoint being part of a local network segment;
drop, by the data plane, the link-local multicast or broadcast message in hardware, such that the link-local multicast or broadcast message is not flooded on the local network segment;
copy, by the data plane, the link-local multicast or broadcast message to the CPU; and
process, using the CPU, the link-local multicast or broadcast message received from the data plane.

18. The network device of claim 17 wherein the link-local multicast or broadcast message is a Dynamic Host Configuration Protocol (DHCP) message or a multicast Domain Name System (mDNS) message.

19. A method performed by a network device for suppressing flooding of link-local multicast or broadcast traffic, the method comprising:
receiving a link-local multicast or broadcast message from an endpoint that is connected to the network device, the device being part of a local network segment;
preventing the link-local multicast or broadcast message from being flooded on the local network segment; and
processing the link-local multicast or broadcast message via a CPU of the network device, the processing being performed in accordance with a networking protocol to which the link-local multicast or broadcast message pertains.

20. The method of claim 19 wherein the networking protocol is Dynamic Host Configuration Protocol (DHCP) or multicast Domain Name System (mDNS).
